(19) United States
(12) Patent Application Publication
(10) Pub. No.: US 2009/0151221 A1
(43) Pub. Date: Jun. 18, 2009

(54) SIGNALING RODENT TRAP SYSTEM

(76) Inventor: James D. Daley, Westlake Village, CA (US)

Correspondence Address: ITALIA IP, 3500 WEST OLIVE AVE., SUITE 300, BURBANK, CA, 91505, US

(21) Appl. No.: 11/957,402

(22) Filed: Dec. 14, 2007

(51) Int. Cl. A01M 23/00

(52) U.S. Cl. 43/58

(57) ABSTRACT

A signaling rodent trap system, the system comprising a signal transmitting device, wherein said signal transmitting device includes a motion triggered switch, a rf transmitter electronically connected to said switch for generating a rf signal only when said motion trigger switch is activated, a power source that is utilized to power said rf transmitter only when said motion triggered switch is activated, and, means for attaching said signal transmitting device to a rodent trap; and, a signal receiving device, wherein said signal receiving device includes a rf receiver for receiving said rf signal from said transmitter, a signaling mechanism for indicating a rf signal has been received by said receiver, a processor electronically connected between said signaling mechanism and said rf receiver for activating said signaling mechanism when a rf signal is received by said receiver, and, a power source for powering said signal receiving device.

### BACKGROUND OF INVENTION

This application relates generally to rodent traps. More specifically, this application relates to a signaling rodent trap system that utilizes wireless communication to indicate whether a given rodent trap has sprung.

### SUMMARY

Conventional devices for trapping rodents, such as mice or rats, are well known. One limitation to such traps is a user must continually check the state of a trap to see if (1) the trap was successful so as to dispose of the rodent; or (2) was unsuccessful but triggered, requiring the user reset the trap. Complicating matters is the general fact that rodent traps are often most successful when they are set to capture rodents in difficult to reach locations such as attics, basements, crawl spaces, cabinets, and behind furniture. As such, this makes it difficult for a user to check the state of a trap or traps. Described herein is a signaling rodent trap system trap system that is easy to use and solves the problems mentioned above. The device is of simple construction, inexpensive to produce, economical to maintain, and can be used in conjunction with all forms of rodent traps. Further, it can be used with traps previously purchased by a user.

In particular, this application discloses a signaling rodent trap system, the system comprising a signal transmitting device, wherein said signal transmitting device includes a motion triggered switch, a rf transmitter electronically connected to said switch for generating a rf signal only when said motion trigger switch is activated, a power source that is utilized to power said rf transmitter only when said motion triggered switch is activated, and, means for attaching said signal transmitting device to a rodent trap; and, a signal receiving device, wherein said signal receiving device includes a rf receiver for receiving said rf signal from said transmitter, a signaling mechanism for indicating a rf signal has been received by said receiver, a processor electronically connected between said signaling mechanism and said rf receiver for activating said signaling mechanism when a rf signal is received by said receiver, and, a power source for powering said signal receiving device.

This application also discloses a signaling rodent trap system, the system comprising a signal transmitting device, wherein said signal transmitting device includes a motion triggered switch, a rf transmitter switch for selecting between two or more rf signals, two or more rf transmitters electronically connected to said switch for generating a rf signal, wherein said rf signal is transmitted only when said motion trigger switch is activated, a power source that is utilized to power said rf transmitter only when said motion triggered switch is activated, and, means for attaching said signal transmitting device to a rodent trap; and, a signal receiving device, wherein said signal receiving device includes: a rf receiver for receiving said rf signal from said transmitter, wherein said receiver is capable of receiving two or more rf signals, a signaling mechanism for indicating a rf signal has been received by said receiver, a processor electronically connected between said signaling mechanism and said rf receiver for activating said signaling mechanism when a rf signal is received by said receiver, wherein said processor is capable of distinguishing between two or more rf signals, such that a different signaling mechanism is activated for each rf signal received, and, a power source for powering said signal receiving device.

This application further a signaling rodent trap system, the system comprising a signal transmitting device, wherein said signal transmitting device includes a motion triggered switch, a rf transmitter electronically connected to said switch for generating a rf signal only when said motion trigger switch is activated, a power source that is utilized to power said rf transmitter only when said motion triggered switch is activated, and, means for attaching said signal transmitting device to a rodent trap; a signal receiving device, wherein said signal receiving device includes a rf receiver for receiving said rf signal from said transmitter, a signaling mechanism for indicating a rf signal has been received by said receiver, a processor electronically connected between said signaling mechanism and said rf receiver for activating said signaling mechanism when a rf signal is received by said receiver, and, a power source for powering said signal receiving device; and, a rodent trap.

### BRIEF DESCRIPTION OF THE DRAWINGS

The drawings, when considered in connection with the following description, are presented for the purpose of facilitating an understanding of the subject matter sought to be protected.

FIG. 1 is a perspective view of a first embodiment of a signal transmitting device disclosed herein;

FIG. 2 is a perspective view of a second embodiment of a signal transmitting device disclosed herein;

FIG. 3 is a perspective view of a signal receiving device disclosed herein;

FIG. 4 is a schematic of the circuitry of the signal transmitting device in FIG. 1;

FIG. 5 is a schematic of a first embodiment of the circuitry of the signal receiving device in FIG. 3;

FIG. 6 is a schematic of the circuitry of the signal transmitting device in FIG. 2;

FIG. 7 is a schematic of a second embodiment of the circuitry of the signal receiving device in FIG. 3;

FIG. 8 is a schematic showing the application of the signaling rodent trap system disclosed herein;

FIG. 9 is a perspective view of a signal transmitting device shown associated with a traditional rodent trap;

FIG. 10 is a perspective view of a signal transmitting device shown associated with a clamping rodent trap;

FIG. 11 is a perspective view of a signal transmitting device shown associated with a live catch rodent trap; and,

FIG. 12 is a perspective view of a signal transmitting device shown associated with a sticky pad rodent trap;

### DETAILED DESCRIPTION

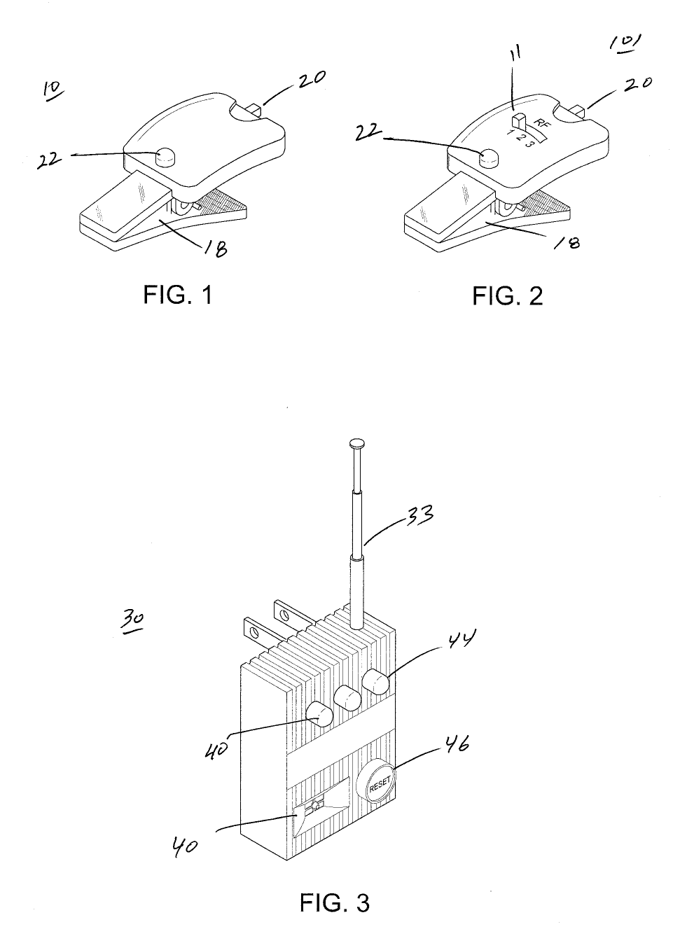

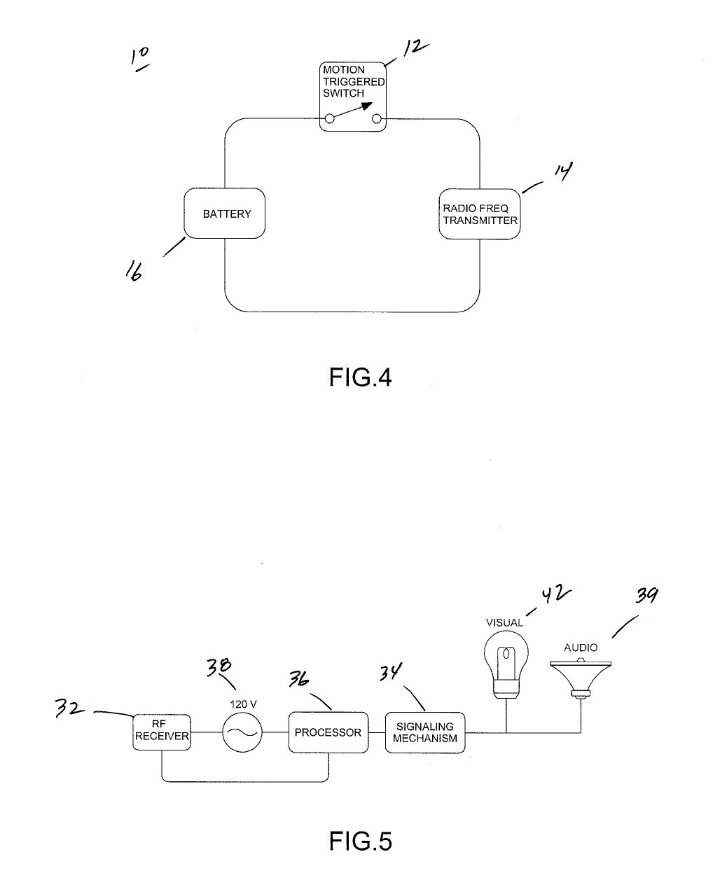

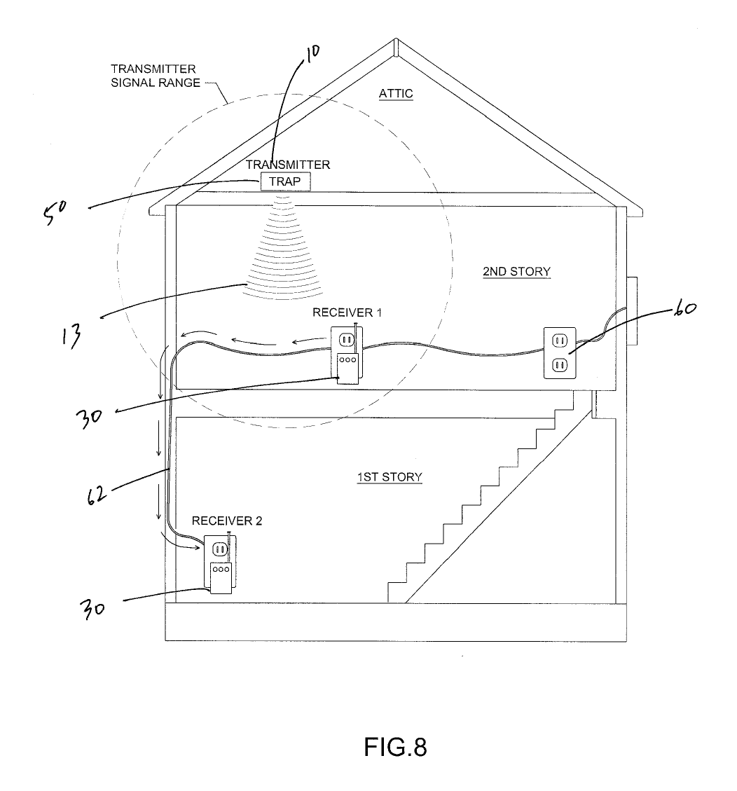

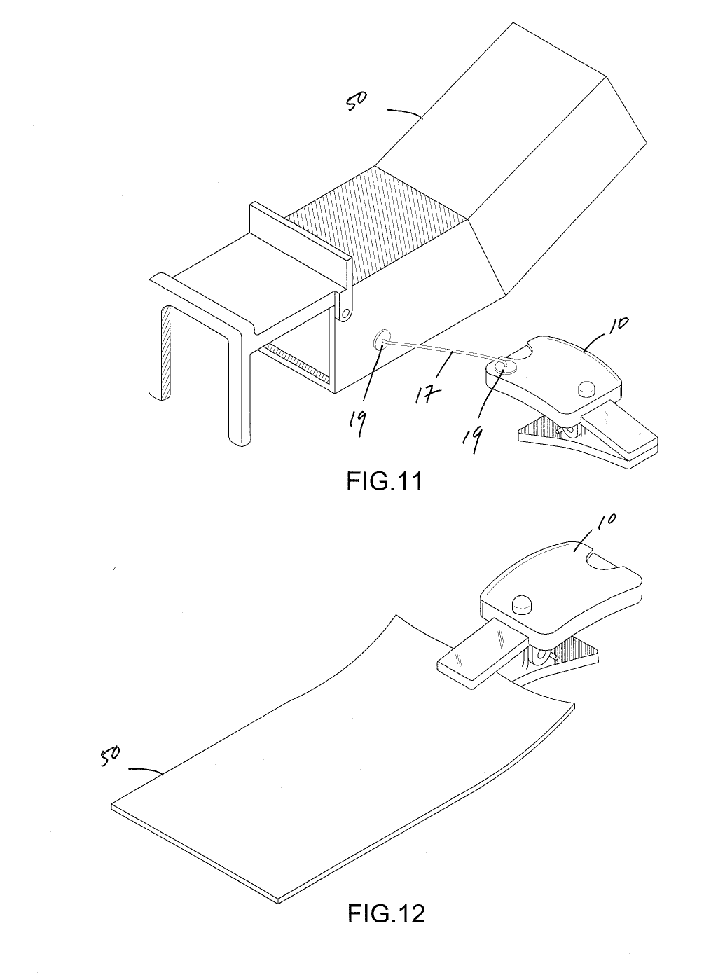

Referring to FIG. 8, shown therein is a schematic showing the application of the signaling rodent trap system disclosed herein. The system includes a signal transmitting device 10 that is capable of attaching to a rodent trap 50 and a signal receiving device 30. Referring now to FIGS. 1 and 4, shown therein is a first embodiment of signal transmitting device 10 and a schematic of the circuitry of that signal transmitting device 10. The signal transmitting device 10 includes a motion triggered switch 12, a rf transmitter 14 electronically connected to said switch for generating a rf signal 13 when the motion trigger switch 12 is activated. The signal transmitting device 10 also includes and a power source such a battery (rechargeable or standard) 16 and means for attaching the signal transmitting device to a rodent trap 50, such as a spring loaded clip 18. An additional attachment means is shown in FIG. 11. As shown in FIG. 4, the battery 16 is only utilized to power the rf transmitter 14 when the motion triggered switch 13 is activated, thereby conserving battery life. The signal transmitting device 10 may also include an on and off switch 20, such that when the transmitting device 10 is being transported, the motion triggered switch 12 can be deactivated to prevent a rf signal 13 from being continuously transmitted, thereby depleting the battery 16. The signal transmitting device 10 may also include an indicator 22 such as a LED that is used to indicate to a user that that the motion triggered switch 12 has been activated. The indicator is helpful in determining that the battery is operation, that the device is on or off, and/or that signal transmitting device 10 is functioning properly.

Referring now to FIGS. 3 and 5, shown therein is a signal receiving device 30 and a schematic of a first embodiment of the circuitry of the signal receiving device 30. The signal receiving device 30 includes a rf receiver 32 for receiving a rf signal 13 from the rf transmitter 14 of the signal transmitting device 10. An antenna 33 can be utilized to increase the range of the rf receiver 32 as is well known in the art. The signal receiving device 30 also includes a signaling mechanism 34 for indicating a rf signal 13 has been received by the rf receiver 32. A processor 36 electronically connected between the signaling mechanism 34 and the rf receiver 32 is used for activating the signaling mechanism 34 when a rf signal 13 is received by the rf receiver 32. A power source is included to power the signal receiving device 30, as shown the device 30 utilizes 120 V 38 from a common A/C source. It is contemplated that the power source could also be a battery (rechargeable or standard). The signaling mechanism 34 may include an audible signal 39 from a speaker source 40 or a visual signal 42 from a powered light source 44. The signal receiving device 30 may also include a reset button 46 for resetting the processor 36 and signaling mechanism 34 when pressed.

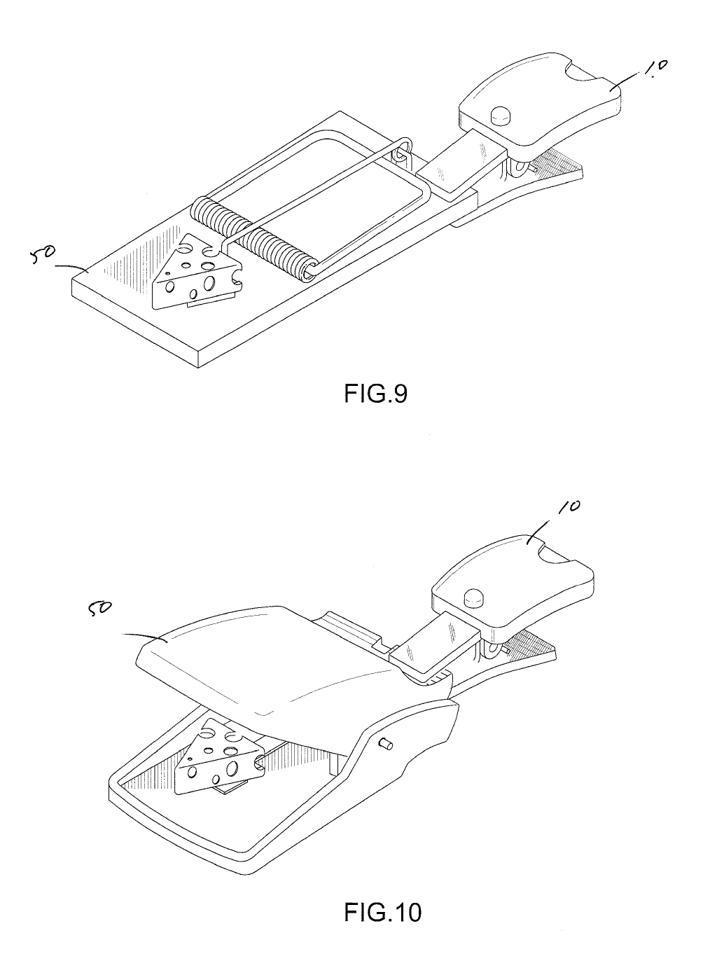

During operation, the signal transmitting device 10 is attached to a rodent trap 50, such as a mouse or rat trap. See FIGS. 9-12 for examples of the signal transmitting device 10 attached to various forms of rodent traps 50. The signal receiving device 30 is then plugged in to a common outlet 60. See FIG. 8. When the trap is triggered or a rodent in some way causes a vibration in the trap, the motion triggered switch 12 of the signal transmitting device 10 is activated, the circuit is closed, and a rf signal 13 generated by the rf transmitter 14. An in range signal receiving device 30 receives the signal 13 which in turn causes the processor 36 to activate the signaling mechanism 34, thereby indicating to a user that the rodent trap 50 has either been triggered or has been disturbed in some way. Additionally, as shown in FIG. 8, the signal receiving device 30 can transmit a signaling mechanism through the wiring 62 to a second signal receiving device 301 so as to generate a signaling mechanism in the second signal receiving device 301. This is particularly useful when the second signaling device 301 is out of range and therefore unable to receive the initial rf signal 13 from the signal transmitting device 10.

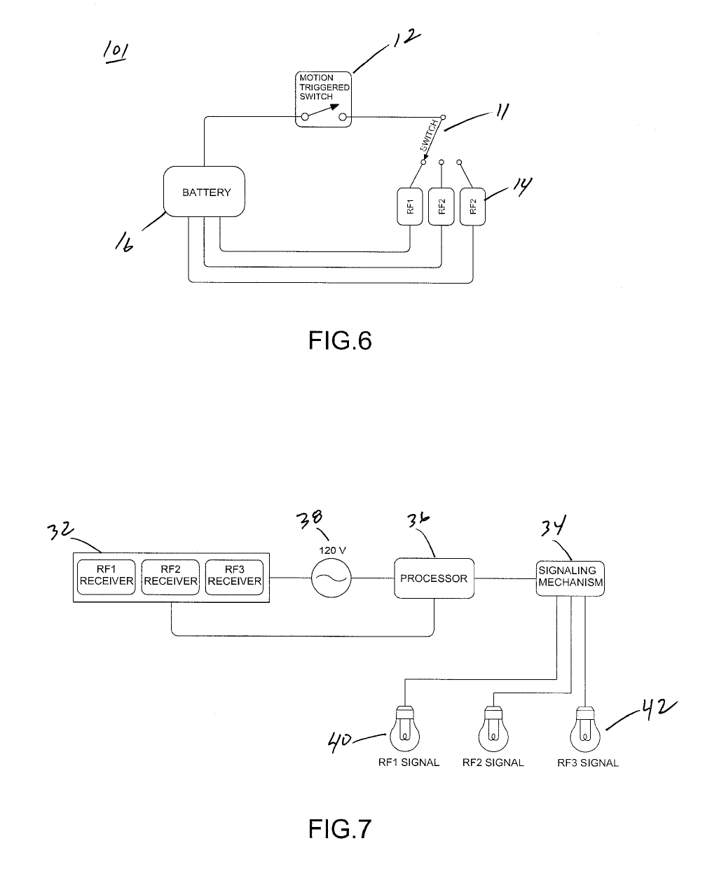

A second embodiment of the signaling rodent trap system is shown in FIGS. 2, 6, and 7. In this embodiment, the signal transmitting device 101 is capable generating more than one rf signal, and the signal receiving device 30 is capable of receiving more than one rf signal 13. More specifically, the signal transmitting device 101 includes a rf transmitter switch 11 for selecting between two or more rf signals 13 to be generated by two or more rf transmitters 14. Therefore, in this embodiment, you could have a plurality of signal transmitting devices 101 in different locations each sending a specific rf signal 13 that can be used to determine the location of a given signal transmitting device 101. As described above, in this embodiment as well, the rf signal 13 is transmitted only when the motion trigger switch 12 is activated, thereby conserving battery life. Likewise, the signal receiving device 30 includes a rf receiver 32 that is capable of receiving two or more rf signals 13, a signaling mechanism 34 for indicating a rf signal 13 has been received and a processor 36 electronically connected between the signaling mechanism 34 and the rf receiver 32 for activating the signaling mechanism 34 when a rf signal 13 is received by the rf receiver 32. In this embodiment, the processor 36 is capable of distinguishing between two or more rf signals, such that a different signaling mechanism is activated for each rf signal received. Thus, if you set one signal transmitting device 101 to the first position in the attic, another to the second position in the basement, and another to the third position in the garage, when the first rf signal 40 is activated, the user is made aware that the rodent trap 50 attached to the signal transmitting device 101 in the attic needs to be attended to.

FIGS. 9-12 show examples of the signal transmitting device 10 attached to various forms of rodent traps 50. FIG. 9 is a perspective view of a signal transmitting device shown associated with a traditional rodent trap. FIG. 10 is a perspective view of a signal transmitting device shown associated with a clamping rodent trap. FIG. 11 is a perspective view of a signal transmitting device shown associated with a live catch rodent trap. In this example, a leash 17 with attachable ends 19 is used to connect the signal transmitting device 10 to the trap 50, such that when the rodent is captured, the vibration from the trap 50 is transferred to the leash 17 and then to the attached signal transmitting device 10, thereby activating the motion triggered switch 12. FIG. 12 is a perspective view of a signal transmitting device shown associated with a sticky pad rodent trap.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A signaling rodent trap system, the system comprising:
a signal transmitting device, wherein said signal transmitting device includes:
(a) a motion triggered switch,
(b) a rf transmitter electronically connected to said switch for generating a rf signal only when said motion trigger switch is activated,
(c) a power source that is utilized to power said rf transmitter only when said motion triggered switch is activated, and,
(d) means for attaching said signal transmitting device to a rodent trap; and,
a signal receiving device, wherein said signal receiving device includes:
(a) a rf receiver for receiving said rf signal from said transmitter,
(b) a signaling mechanism for indicating a rf signal has been received by said receiver,
(c) a processor electronically connected between said signaling mechanism and said rf receiver for activating said signaling mechanism when a rf signal is received by said receiver, and,
(d) a power source for powering said signal receiving device.

2. The system of claim 1, wherein said signal receiving device includes means for resetting said receiving devices when the signaling mechanism is activated.

3. The system of claim 1, wherein the signaling mechanism of said signal receiving device is visual.

4. The system of claim 1, wherein the signaling mechanism of said signal receiving device is audible.

5. The system of claim 1, wherein the signaling mechanism of said signal receiving device is visual and audible.

6. The device of claim 1, wherein the signal transmitting device further comprises and on and off switch.

7. The system of claim 1, wherein the signal transmitting device further comprises an indicator that the motion triggered switch has been activated.

8. The system of claim 1, wherein the means for attaching signal transmitting devise to said rodent trap is a spring loaded clip.

9. The system of claim 1, wherein said signal receiving device can transmit a signaling mechanism to a second signal receiving device so as to generate a signaling mechanism in said second signal receiving device, wherein said second signaling device unable to receive the initial rf signal from said signal transmitting device.

10. A signaling rodent trap system, the system comprising:
a signal transmitting device, wherein said signal transmitting device includes:
(a) a motion triggered switch,
(b) a rf transmitter switch for selecting between two or more rf signals,
(c) two or more rf transmitters electronically connected to said switch for generating a rf signal, wherein said rf signal is transmitted only when said motion trigger switch is activated,
(d) a power source that is utilized to power said rf transmitter only when said motion triggered switch is activated, and,
(e) means for attaching said signal transmitting device to a rodent trap; and,
a signal receiving device, wherein said signal receiving device includes:
(a) a rf receiver for receiving said rf signal from said transmitter, wherein said receiver is capable of receiving two or more rf signals,
(b) a signaling mechanism for indicating a rf signal has been received by said receiver,
(c) a processor electronically connected between said signaling mechanism and said rf receiver for activating said signaling mechanism when a rf signal is received by said receiver, wherein said processor is capable of distinguishing between two or more rf signals, such that a different signaling mechanism is activated for each rf signal received, and,
(d) a power source for powering said signal receiving device.

11. The system of claim 10, wherein said signal receiving device includes means for resetting said receiving devices when the signaling mechanism is activated.

12. The system of claim 10, wherein the signaling mechanism of said signal receiving device is visual.

13. The system of claim 10, wherein the signaling mechanism of said signal receiving device is audible.

14. The system of claim 10, wherein the signaling mechanism of said signal receiving device is visual and audible.

15. The system of claim 10, wherein the signal transmitting device further comprises and on and off switch.

16. The system of claim 10, wherein the signal transmitting device further comprises an indicator that the motion triggered switch has been activated.

17. The system of claim 10, wherein the means for attaching signal transmitting devise to said rodent trap is spring loaded clip.

18. The system of claim 10, wherein said signal receiving device can transmit a signaling mechanism to a second signal receiving device so as to generate a signaling mechanism in said second signal receiving device, wherein said second signaling device unable to receive the initial rf signal from said signal transmitting device.

19. The system of claim 10, further comprising a rodent trap.

20. A signaling rodent trap system, the system comprising:
a signal transmitting device, wherein said signal transmitting device includes:
(a) a motion triggered switch,
(b) a rf transmitter electronically connected to said switch for generating a rf signal only when said motion trigger switch is activated,
(c) a power source that is utilized to power said rf transmitter only when said motion triggered switch is activated, and,
(d) means for attaching said signal transmitting device to a rodent trap;
a signal receiving device, wherein said signal receiving device includes:
(a) a rf receiver for receiving said rf signal from said transmitter,
(b) a signaling mechanism for indicating a rf signal has been received by said receiver,
(c) a processor electronically connected between said signaling mechanism and said rf receiver for activating said signaling mechanism when a rf signal is received by said receiver, and,
(d) a power source for powering said signal receiving device; and,
a rodent trap.
